(19) United States
(12) Patent Application Publication
(10) Pub. No.: US 2026/0258839 A1
(43) Pub. Date: Sep. 3, 2026

(54) GAP-ADJUSTABLE SLIDING SUBASSEMBLY AND SLIDING APPARATUS

(71) Applicant: HANGZHOU AIZHU TECHNOLOGY CO., LTD., Hangzhou (CN)

(72) Inventor: Xianyun CHEN, Hangzhou (CN)

(73) Assignee: HANGZHOU AIZHU TECHNOLOGY CO., LTD., Hangzhou (CN)

(21) Appl. No.: 19/654,814

(22) Filed: Apr. 22, 2026

Related U.S. Application Data
(63) Continuation of application No. PCT/CN2024/123504, filed on Oct. 13, 2024.

(30) Foreign Application Priority Data
Oct. 25, 2023 (CN) 202322866228.6

(51) Int. Cl. F16C 29/00; F16C 29/04

(52) U.S. Cl. CPC F16C 29/001; F16C 29/004; F16C 29/043

(57) ABSTRACT

Provided are a gap-adjustable sliding subassembly and a sliding apparatus. The sliding subassembly includes at least three sliding members, and the sliding members are in rolling connection with guide rails, so that the sliding subassembly is capable of sliding on the guide rails; the sliding subassembly further includes a first panel and a second panel which are fixedly connected, the sliding members are mounted between the first panel and the second panel, the first panel and the second panel are provided with oblong holes which are in one-to-one correspondence, and at least one of the sliding members is mounted between the oblong holes for adjusting a gap between the sliding subassembly and the guide rails.

### CROSS-REFERENCE TO RELATED APPLICATIONS

This application is the U.S. continuation of application of International Application No. PCT/CN2024/123504 filed on 13 October 2024 which designated the U.S. and claims priority to Chinese Application No. CN202322866228.6 filed on 25 October 2023, the entire contents of each of which are hereby incorporated by reference.

### TECHNICAL FIELD

The present disclosure belongs to the technical field of movement control mechanical devices, and particularly relates to a gap-adjustable sliding subassembly and a sliding apparatus.

### BACKGROUND

Sliding apparatus is widely used, and generally includes a sliding subassembly and a guiding subassembly. The sliding subassembly is provided with at least three sliding members, and the guiding subassembly is provided with at least two guide rails. The plurality of sliding members are respectively in rolling connection with the plurality of guide rails of the guiding subassembly, so that the sliding subassembly is capable of sliding along the guide rails of the guiding subassembly. However, due to manufacturing errors or wear caused by long-term use, a gap may occur between the sliding members and the guide rails, thereby affecting the smooth sliding of the sliding subassembly on the sliding apparatus.

The sliding member may be a ball or a pulley. For the pulley used as the sliding member, in existing technical solutions, a panel is generally arranged on the sliding subassembly, and a plurality of pulleys are fixed on an edge of the panel close to the guide rails through bolts, studs and nuts. At least one pulley may be adjusted in position to eliminate the gap between the pulley and the guide rail. A support stud for the adjustable pulley is an eccentric nut stud, and the eccentric nut stud may be rotated to adjust the corresponding pulley to move toward or away from the guide rail, so as to adjust the gap between the pulley and the guide rail.

The guiding subassembly may be designed as an integrated guiding subassembly or a split-type guiding subassembly composed of multiple parts which are assembled into one component through connecting members such as bolts. For example, in Chinese Patent CN210106974U, a guiding subassembly is composed of two guide structural members and two support structural members, and the connection and positioning between the guide structural members and the support structural members are realized by contact connection between V-shaped grooves and V-shaped convex surfaces, and bolts.

In a process of realizing the present disclosure, the inventor found that there are at least the following problems in the prior art:
(1) In the prior art, the pulleys are supported by the single-side panel only, and the single-side panel is subjected to a large bending moment during use, resulting in a weak load-bearing capacity.
(2) In the prior art, the eccentric nut stud is provided to eliminate the gap between the pulleys and the guide rails, and the eccentric nut stud occupies a larger space, resulting in low space utilization efficiency of the structure.
(3) In the prior art, the integrated guiding subassembly design has high process requirements for large sizes and high production costs.
(4) In the prior art, the V-shaped grooves and the V-shaped convex surfaces of the split-type guiding subassembly design are difficult to measure and produce with accurate dimensions, resulting in high overall final production costs.

### SUMMARY

Object of disclosure: the technical problem to be solved by the present disclosure is to provide a gap-adjustable sliding subassembly and a sliding apparatus aiming at the defects in the prior art.

In order to solve the above technical problem, in a first aspect, a gap-adjustable sliding subassembly is disclosed, which includes at least three sliding members, wherein the sliding members are in rolling connection with guide rails, so that the sliding subassembly is capable of sliding on the guide rails; and the sliding subassembly further includes a first panel and a second panel which are fixedly connected, the sliding members are mounted between the first panel and the second panel, the first panel and the second panel are provided with oblong holes which are in one-to-one correspondence, and at least one of the sliding members is mounted between the oblong holes for adjusting a gap between the sliding subassembly and the guide rails.

Further, the sliding member is a pulley; and the sliding subassembly further includes a bolt and a nut, the oblong holes which are in one-to-one correspondence form an oblong hole group, and a position of the pulley between the oblong holes relative to the oblong hole group is capable of being adjusted through the bolt and the nut.

Further, a bearing is arranged in a middle of the pulley between the oblong holes, and the bolt penetrates through the oblong hole in the first panel, a bearing hole in the pulley and the oblong hole in the second panel, and is threadedly connected with the nut.

Further, an inner-conical-surface countersink is arranged on one side of the oblong hole in the first panel opposite to the pulley, and an axis of the inner-conical-surface countersink coincides with or is close to an axis of the oblong hole in the first panel near the guide rail; and the bolt includes an outer-conical-surface head, and the inner-conical-surface countersink is in contact with the outer-conical-surface head of the bolt.

Further, the nut is a polygon‑section nut, a polygonal countersink is arranged on one side of the oblong hole in the second panel opposite to the pulley, the nut is mounted inside the polygonal countersink, and a wedge‑shaped inclined surface in contact with the nut is arranged at a bottom of the polygonal countersink.

By adjusting the threaded connection between the bolt and the nut to shorten a distance between the head of the bolt and the nut, an inner conical surface of the first panel and a wedge-shaped inclined surface of the second panel can respectively push the head of the bolt and the nut toward the guide rail, thereby pushing the pulley toward the guide rail and ultimately eliminating the gap between the pulleys and the rails.

In a second aspect, a sliding apparatus is disclosed, which includes a guiding subassembly and a first sliding subassembly, wherein the first sliding subassembly is the sliding subassembly above, the guiding subassembly includes a first guide rail group the first guide rail group includes oppositely arranged guide rails.

Further, the sliding apparatus further includes a second sliding subassembly, wherein the second sliding subassembly is the sliding subassembly above, and the guiding subassembly further includes a second guide rail group, and the second guide rail group includes oppositely arranged guide rails.

Further, the guiding subassembly includes a guide structural member and a support structural member, the guide rails are arranged on the guide structural member, and the guide structural member and the support structural member are connected end-to-end to form a rectangular frame of the guiding subassembly.

Further, the support structural member includes a first through hole and a wedge-shaped countersink, one end of the first through hole is connected with one end of the wedge-shaped countersink, and a combination of the first through hole and the wedge-shaped countersink penetrates through the support structural member; and an end of the guide structural member includes a threaded hole, and the end of the guide structural member is fixedly connected with the support structural member by allowing a connecting member to penetrate through the wedge-shaped countersink, the first through hole and the threaded hole.

Further, the connecting member includes a wedge-shaped block and a fixing bolt, the wedge-shaped block is provided with a penetrative second through hole, the wedge-shaped block is mounted in the wedge-shaped countersink of the support structural member, and the fixing bolt penetrates through the second through hole and the first through hole to connect with the guide structural member; and the support structural member further includes a first positioning surface and a third positioning surface, the end of the guide structural member includes a second positioning surface and a fourth positioning surface, the second positioning surface is in contact connection with the first positioning surface, and the third positioning surface is in contact connection with the fourth positioning surface.

By adjusting the threaded connection between the fixing bolt and the threaded hole of the guide structural member to shorten a distance between the head of the fixing bolt and the end of the guide structural member, the wedge-shaped block may be pushed to move axially relative to the wedge-shaped countersink of the support structural member, and meanwhile, the wedge-shaped countersink pushes the wedge-shaped block and the fixing bolt mounted inside the wedge-shaped block to move transversely through the wedge-shaped surface, and the fixing bolt drives the guide structural member toward the support structural member, so that the second positioning surface of the guide structural member comes into contact with the first positioning surface of the support structural member, and the fourth positioning surface of the guide structural member comes into contact with the third positioning surface of the support structural member at the same time, thereby achieving fixed connection and accurate positioning between the guide structural member and the support structural member.

Beneficial effects: (1) compared with the supporting to the pulleys by a single-side panel in the prior art, the panels on upper and lower sides of the pulleys jointly support the pulleys in the present disclosure, thereby achieving better support stability and better bearing capacity; (2) compared with the elimination of the gap between the pulleys and the guide rails by an eccentric nut stud in the prior art, the inner-conical-surface countersinks and the wedge-shaped inclined surfaces are respectively arranged on the upper and lower panels to eliminate the gap between the pulleys and the guide rails in the present disclosure, without needing the eccentric nut stud in the prior art, so that the structure has higher spatial utilization efficiency; and (3) the connection and positioning between the support structural member and the guide structural member are realized by a simpler planar contact connection method, which has low requirements for production process, thereby achieving lower production costs compared with the prior art.

### BRIEF DESCRIPTION OF THE DRAWINGS

FIG. 1 is a stereoscopic diagram of a sliding apparatus according to an embodiment of the present application;

FIG. 2 is a schematic diagram of a guide rail of a guiding subassembly of the sliding apparatus shown in FIG. 1;

FIG. 3 is a first stereoscopic diagram of an overall structure of a second sliding subassembly of the sliding apparatus shown in FIG. 1;

FIG. 4 is a second stereoscopic diagram of the overall structure of the second sliding subassembly shown in FIG. 3;

FIG. 5 is a partial exploded view of the second sliding subassembly shown in FIG. 3;

FIG. 6 is a schematic diagram of a first panel of the second sliding subassembly shown in FIG. 3;

FIG. 7 is a schematic diagram of a second panel of the second sliding subassembly shown in FIG. 3;

FIG. 8 is a schematic diagram of the second panel of the second sliding subassembly shown in FIG. 3 from another perspective;

FIG. 9 is a partial sectional view of the guiding subassembly and the second sliding subassembly in the sliding apparatus shown in FIG. 1 after slidable connection;

FIG. 10 is a partial exploded view of the guiding subassembly of the sliding apparatus shown in FIG. 1;

FIG. 11 is a partial sectional view of the guiding subassembly of the sliding apparatus shown in FIG. 1;

FIG. 12 is a partial schematic diagram of a support structural member of the guiding subassembly of the sliding apparatus shown in FIG. 1;

FIG. 13 is a schematic diagram of an end of a guide structural member of the guiding subassembly of the sliding apparatus shown in FIG. 1;

FIG. 14 is an enlarged view of a wedge-shaped block of the sliding apparatus shown in FIG. 10; and

FIG. 15 is a physical view of the sliding apparatus of the present application.

Reference numerals or the present disclosure are as follows:

100 refers to guiding subassembly, 200 refers to first sliding subassembly, 300 refers to rotating subassembly, 400 refers to first synchronous belt, 500 refers to second sliding subassembly, 600 refers to second synchronous belt, 101 refers to guide rail, 102 refers to guide structural member, 103 refers to support structural member, 104 refers to first positioning surface, 115 refers to third positioning surface, 105 refers to wedge-shaped block, 106 refers to wedge-shaped surface of wedge-shaped block, 107 refers to fixing bolt, 108 refers to wedge-shaped countersink of support structural member, 109 refers to wedge-shaped surface of wedge-shaped countersink, 110 refers to end threaded hole of guide structural member, 111 refers to second through hole, 112 refers to first through hole, 113 refers to second positioning surface, 114 refers to fourth positioning surface, 11 refers to first guide rail group, 12 refers to second guide rail group, 501 refers to pulley, 52 refers to first panel, 53 refers to second panel, 504 refers to countersunk bolt, 505 refers to lock nut, 506 refers to connection interface with supporting apparatus, 521 refers to oblong hole in first panel, 522 refers to inner-conical-surface countersink of first panel, 523 refers to axis of oblong hole in first panel near guide rail, 524 refers to axis of oblong hole in first panel far away from guide rail, 531 refers to oblong hole in second panel, 532 refers to polygonal countersink of second panel, and 533 refers to wedge-shaped inclined surface of second panel.

### DETAILED DESCRIPTION

The technical solution of the present disclosure will be described in detail hereinafter with reference to the drawings.

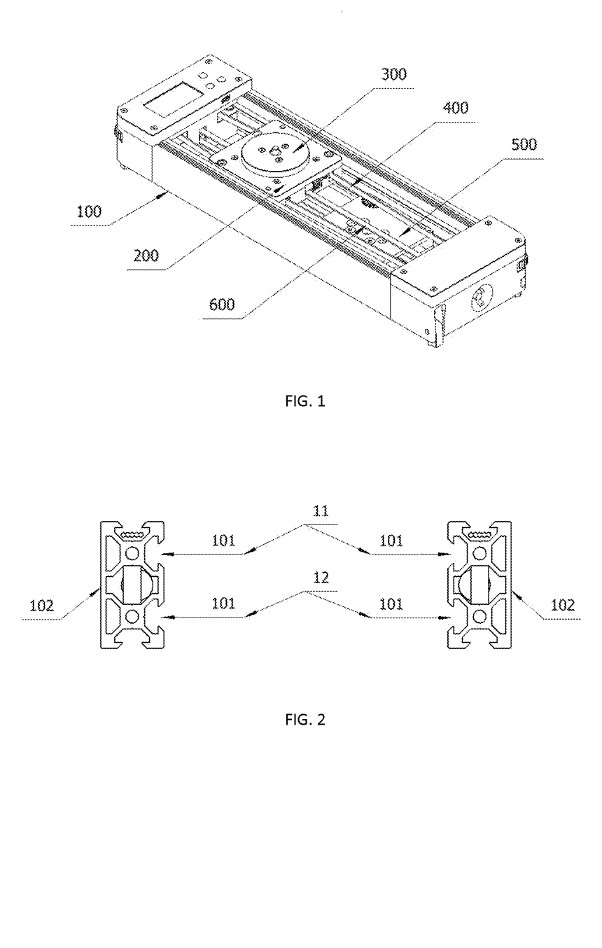

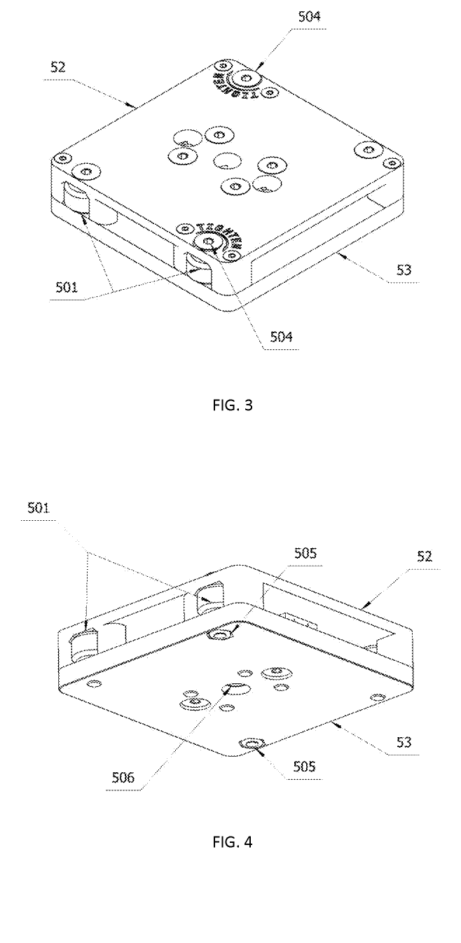

As shown in FIG. 1 and FIG. 3, the present disclosure provides a gap-adjustable sliding subassembly and a sliding apparatus used for translational movement of a device such as a camera and a 3D printer.

A first embodiment of the present application discloses a gap-adjustable sliding subassembly, which includes at least three sliding members, wherein the sliding members are in rolling connection with guide rails, so that the sliding subassembly is capable of sliding on the guide rails; and the sliding subassembly further includes a first panel and a second panel which are fixedly connected, the sliding members are mounted between the first panel and the second panel, the first panel and the second panel are provided with oblong holes which are in one-to-one correspondence, and at least one of the sliding members is mounted between the oblong holes for adjusting a gap between the sliding subassembly and the guide rails.

The sliding member is a pulley, and the sliding subassembly further includes a bolt and a nut. Preferably, the bolt and the nut are a countersunk bolt and a lock nut respectively. The oblong holes which are in one-to-one correspondence form an oblong hole group, and a position of the pulley between the oblong holes relative to the oblong hole group is capable of being adjusted through the bolt and the nut.

A bearing is arranged in a middle of the pulley between the oblong holes. The bolt penetrates through the oblong hole in the first panel, a bearing hole in the pulley and the oblong hole in the second panel, and is threadedly connected with the nut.

An inner-conical-surface countersink is arranged on one side of the oblong hole in the first panel opposite to the pulley, and an axis of the inner-conical-surface countersink coincides with or is close to an axis of the oblong hole in the first panel near the guide rail. The bolt includes an outer-conical-surface head, and the inner-conical-surface countersink is in contact with the outer-conical-surface head of the bolt.

The nut is a polygon‑section nut, a polygonal countersink is arranged on one side of the oblong hole in the second panel opposite to the pulley, and the nut is mounted inside the polygonal countersink. A wedge‑shaped inclined surface in contact with the nut is arranged at a bottom of the polygonal countersink.

A second embodiment of the present application discloses a sliding apparatus, which includes a guiding subassembly and a first sliding subassembly, wherein the first sliding subassembly is the sliding subassembly above, the guiding subassembly includes a first guide rail group. The first guide rail group includes oppositely arranged guide rails.

The sliding apparatus further includes a second sliding subassembly, wherein the second sliding subassembly is the sliding subassembly above, and the guiding subassembly further includes a second guide rail group, and the second guide rail group includes oppositely arranged guide rails.

The guiding subassembly includes a guide structural member and a support structural member, the guide rails are arranged on the guide structural member, and the guide structural member and the support structural member are connected end-to-end to form a rectangular frame of the guiding subassembly.

The support structural member includes a first through hole and a wedge-shaped countersink, one end of the first through hole is connected with one end of the wedge-shaped countersink, and a combination of the first through hole and the wedge-shaped countersink penetrates through the support structural member; and an end of the guide structural member includes a threaded hole, and the end of the guide structural member is fixedly connected with the support structural member by allowing a connecting member to penetrate through the wedge-shaped countersink, the first through hole and the threaded hole.

The connecting member includes a wedge-shaped block and a fixing bolt, the wedge-shaped block is provided with a penetrative second through hole, the wedge-shaped block is mounted in the wedge-shaped countersink of the support structural member, and the fixing bolt penetrates through the second through hole and the first through hole to connect with the guide structural member; and the support structural member further includes a first positioning surface and a third positioning surface, the end of the guide structural member includes a second positioning surface and a fourth positioning surface, the second positioning surface is in contact connection with the first positioning surface, and the third positioning surface is in contact connection with the fourth positioning surface.

Embodiment 1:

A sliding apparatus includes: a guiding subassembly 100, a first sliding subassembly 200 slidably connected with the guiding subassembly 100, a rotating subassembly 300 rotatably connected with the first sliding subassembly 200, and a first synchronous belt 400 connecting the guiding subassembly 100 and the first sliding subassembly 200. The rotating subassembly 300 includes a mounting platform provided with an interface for connecting a load, and the load may be a camera, a printing platform of a 3D printer, or the like. The sliding apparatus further includes a second sliding subassembly 500 slidably connected with the guiding subassembly 100, and a second synchronous belt 600 fixedly connected with the first sliding subassembly 200 and the second sliding subassembly 500. A connection interface 506 with a supporting apparatus is arranged at a bottom of the second sliding subassembly 500, and the supporting apparatus may be a tripod or the like.

As shown in FIG. 2, the guiding subassembly 100 includes four guide rails 101, wherein the four guide rails 101 are divided into a first guide rail group 11 near an upper part and a second guide rail group 12 near a lower part. The first sliding subassembly 200 is slidably connected with the first guide rail group 11 of the guiding subassembly, and the second sliding subassembly 500 is slidably connected with the second guide rail group 12 of the guiding subassembly. Since the first sliding subassembly 200 and the second sliding subassembly 500 have similar structures and arrangements, the second sliding subassembly 500 is taken as an example for description below.

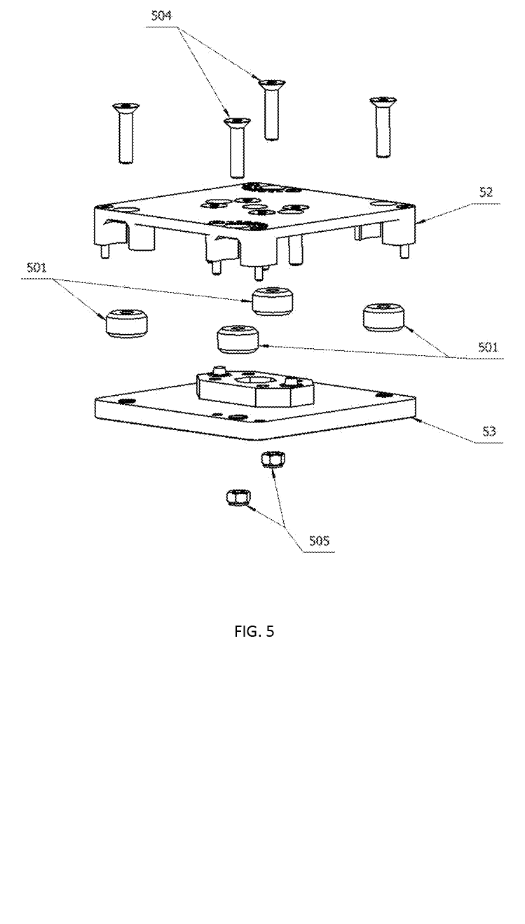

With reference to FIG. 3, FIG. 4 and FIG. 5, the second sliding subassembly 500 includes four pulleys 501, wherein the four pulleys 501 are in rolling connection with the second guide rail group 12 of the guiding subassembly 500 so that the second sliding subassembly 500 can slide along the second guide rail group 12. The second sliding subassembly 500 includes a first panel 52 and a second panel 53 which are fixedly connected, and the four pulleys 501 are mounted between the first panel 52 and the second panel 53.

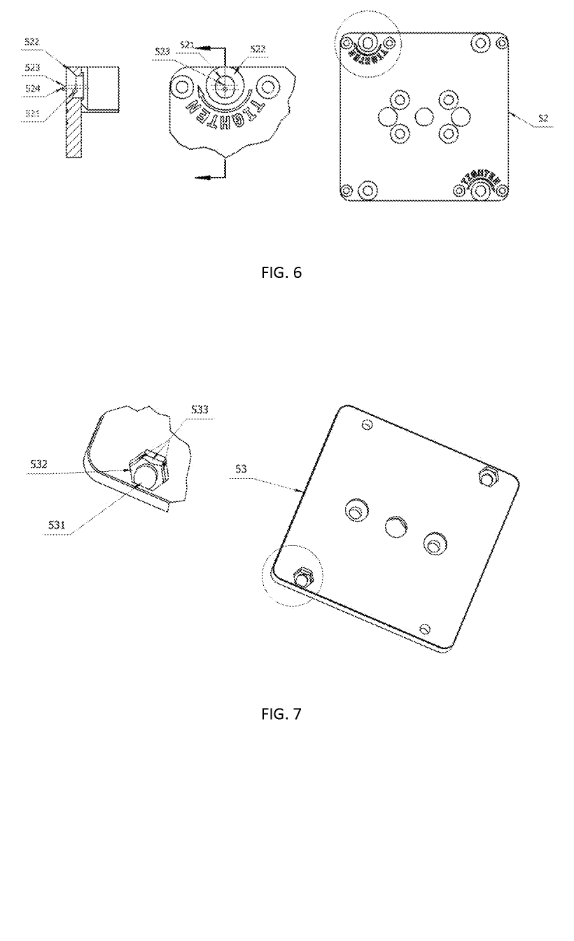

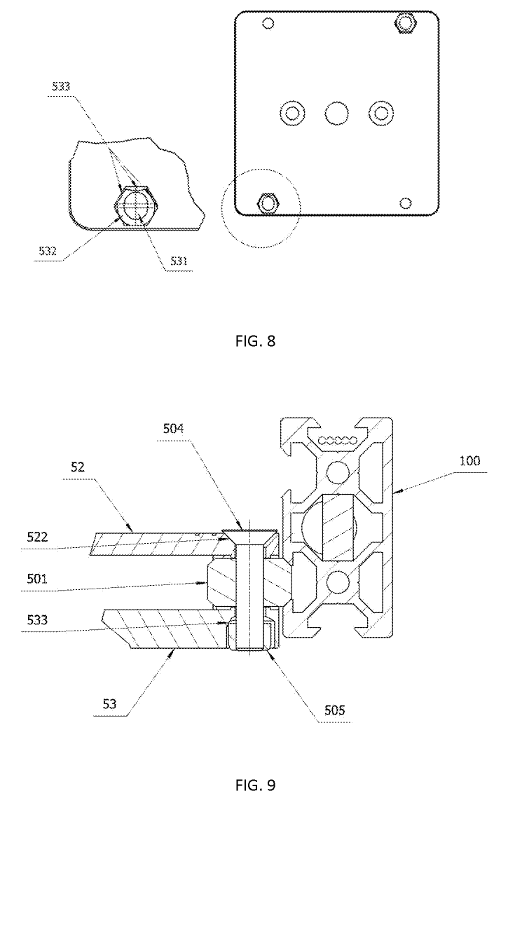

With reference to FIG. 6, FIG. 7, FIG. 8 and FIG. 9, the first panel 52 and the second panel 53 are provided with two groups of oblong holes which are in one-to-one correspondence. Each group of oblong holes which are in one-to-one correspondence forms an oblong hole group, and each group includes an oblong hole 521 in the first panel and an oblong hole 531 in the second panel respectively. One pulley 501 is mounted between each group of oblong holes, and the pulley between each group of oblong holes is mounted through one countersunk bolt 504 and one lock nut 505. A position of the pulley 501 between each group of oblong holes relative to the oblong hole group may be adjusted through the corresponding countersunk bolt 504 and lock nut 505.

As shown in FIG. 6 and FIG. 9, the countersunk bolt 504 includes an outer-conical-surface head, a bearing is arranged in a middle of the pulley 501, and the countersunk bolt 504 penetrates through the oblong hole 521 in the first panel, a bearing hole in the pulley 501 and the oblong hole 531 in the second panel, and is threadedly connected with the lock nut 505. An inner-conical-surface countersink 522 is arranged on one side of the oblong hole 521 in the first panel opposite to the pulley, and a cross‑section of the oblong hole 521 in the first panel is composed of two semicircular arcs and two straight lines, and includes two axes penetrating through centers of the two semicircular arcs respectively: an axis 523 of the oblong hole in the first panel near the guide rail and an axis 524 of the oblong hole in the first panel far away from the guide rail, wherein the axis of the inner-conical-surface countersink 522 coincides with or is close to the axis 523 of the oblong hole in the first panel near the guide rail, and the inner-conical-surface countersink 522 is in contact with the outer-conical-surface head of the countersunk bolt 504.

As shown in FIG. 7, FIG. 8 and FIG. 9, the lock nut 505 is a polygon‑section lock nut, and the countersunk bolt 504 is threadedly connected with the lock nut 505. A polygonal countersink 532 is arranged on one side of the oblong hole 531 in the second panel opposite to the pulley, the lock nut 505 is mounted inside the polygonal countersink 532, and a wedge‑shaped inclined surface 533 in contact with the lock nut is arranged at a bottom of the polygonal countersink 532.

A method for adjusting a gap of the sliding subassembly is as follows: by adjusting the threaded connection between the countersunk bolt 504 and the lock nut 505 to shorten a distance between the head of the countersunk bolt 504 and the lock nut 505, an inner conical surface of the inner-conical-surface countersink 522 of the first panel and a wedge-shaped inclined surface 533 of the second panel can respectively push the head of the countersunk bolt 504 and the lock nut 505 toward the guide rail 101, thereby pushing the pulley 501 toward the guide rail 101 and ultimately eliminating the gap between the pulleys 501 and the rails 101. Compared with the solution of the prior art, the sliding subassembly has a higher load-bearing capacity and does not include an eccentric nut stud in the prior art, resulting in higher structural space utilization efficiency and avoiding the problems in the solution of the prior art.

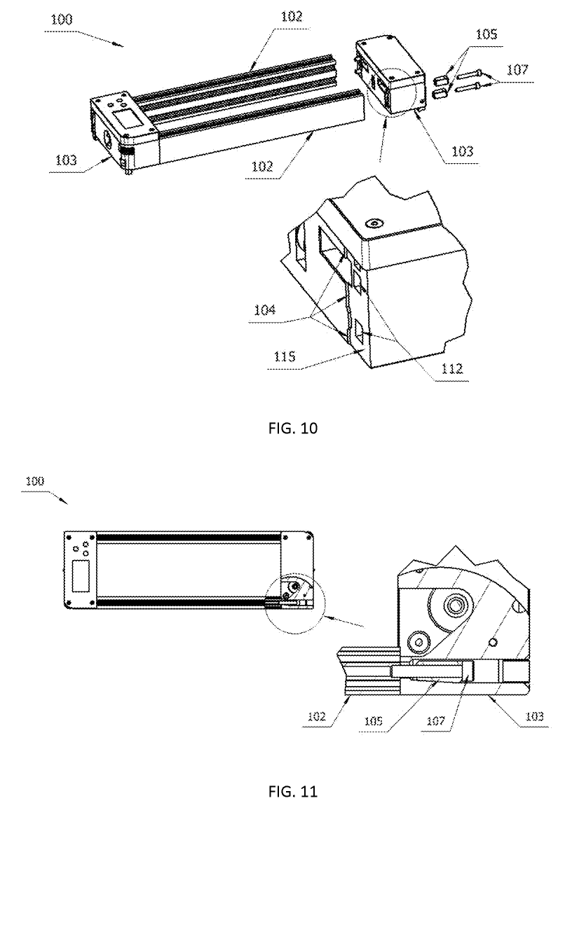

As shown in FIG. 10, the guiding subassembly 100 includes a guide structural member 102 and a support structural member 103. As shown in FIG. 2, the guide rails 101 are arranged on the guide structural member 102, and the guide structural member 102 and the support structural member 103 are connected end-to-end to form a rectangular frame of the guiding subassembly 100.

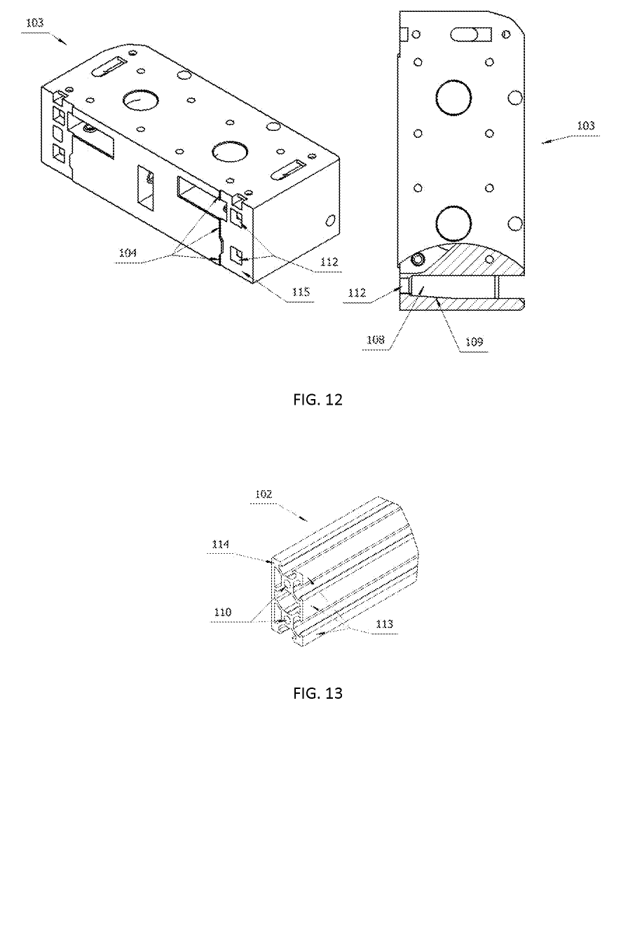

As shown in FIG. 10, FIG. 11, FIG. 12 and FIG. 13, the support structural member 103 includes a first through hole 112 and a wedge-shaped countersink 108, one end of the first through hole 112 is connected with one end of the wedge-shaped countersink 108, and a combination of the first through hole and the wedge-shaped countersink penetrates through the support structural member; and a surface on one side of the wedge-shaped countersink 108 is a wedge-shaped surface 109, an end of the guide structural member 102 includes a threaded hole 110, and the end of the guide structural member 102 is fixedly connected with the support structural member 103 by allowing a connecting member to penetrate through the wedge-shaped countersink, the first through hole and the threaded hole.

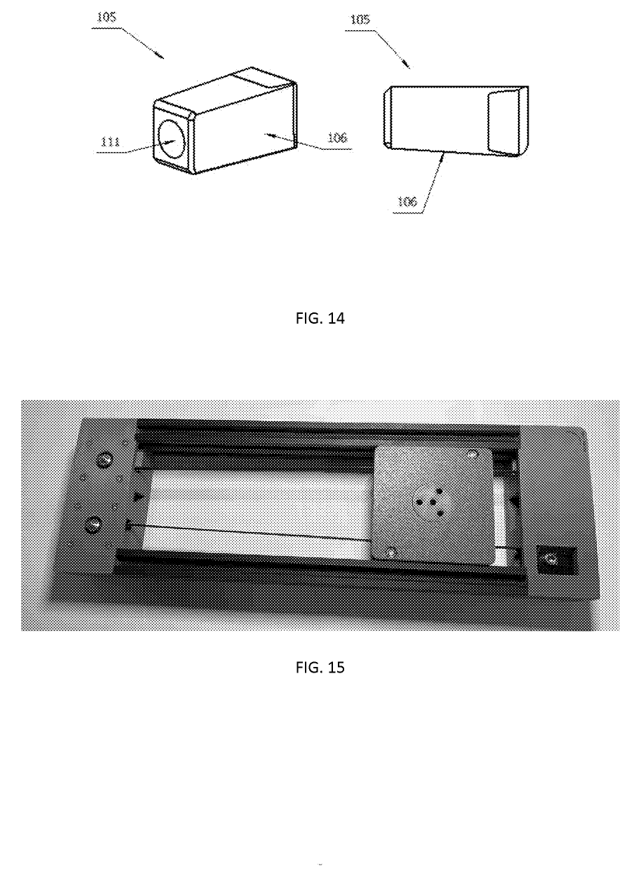

The connecting member includes a wedge-shaped block 105 and a fixing bolt 107, and the wedge-shaped block 105 is provided with a penetrative second through hole 111. As shown in FIG. 14, the wedge-shaped block further includes a wedge-shaped surface 106. As shown in FIG. 11, the wedge-shaped block 105 is mounted in the wedge-shaped countersink 108 of the support structural member 103, and the fixing bolt 107 penetrates through the second through hole 111 of the wedge-shaped block and the first through hole 112 of the support structural member to connect with the threaded hole 110 at the end of the guide structural member 102; and the support structural member 103 further includes a first positioning surface 104 and a third positioning surface 115, the end of the guide structural member 102 includes a second positioning surface 113 and a fourth positioning surface 114, the second positioning surface 113 is in contact connection with the first positioning surface 104, and the third positioning surface 115 is in contact connection with the fourth positioning surface 114.

By adjusting the threaded connection between the fixing bolt 107 and the threaded hole 110 of the guide structural member 102 to shorten a distance between the head of the fixing bolt 107 and the end of the guide structural member 102, the head of the fixing bolt 107 pushes the wedge-shaped block 105 to move axially relative to the wedge-shaped countersink 108 of the support structural member 103, and meanwhile, the wedge-shaped countersink 108 pushes the wedge-shaped block 105 and the fixing bolt 107 mounted inside the wedge-shaped block to move transversely through the wedge-shaped surface 109, and the fixing bolt 107 drives the guide structural member 102 toward the support structural member 103, so that the second positioning surface 113 of the guide structural member 102 comes into contact with the first positioning surface 104 of the support structural member 103, and the fourth positioning surface 114 of the guide structural member 102 comes into contact with the third positioning surface 115 of the support structural member 103 at the same time, thereby achieving fixed connection and accurate positioning between the guide structural member 102 and the support structural member 103.

FIG. 15 shows a physical view of the sliding apparatus. In this embodiment, two rotating sources (motors) are mounted at a left end of the guiding subassembly 100, without mounting the second sliding subassembly 500 and the second synchronous belt 600, which can minimize an overall weight of the apparatus. This physical object is an intermediate achievement during the research and development phase of the present disclosure, and thus differs slightly from the latest designed embodiment described above.

The present disclosure provides the gap-adjustable sliding subassembly and the sliding apparatus, with many methods and ways to realize the technical solution specifically. Those described above are merely the specific embodiments of the present disclosure, and it should be pointed out that those of ordinary skills in the art may further make improvements and decorations without departing from the principle of the present disclosure, and these improvements and decorations should also be regarded as the scope of protection of the present disclosure. All the unspecified components in the embodiments can be realized by the prior art.

What is claimed is:

1. A gap-adjustable sliding subassembly, comprising at least three sliding members, wherein the sliding members are in rolling connection with guide rails, so that the sliding subassembly is capable of sliding on the guide rails; and the sliding subassembly further comprises a first panel and a second panel which are fixedly connected, the sliding members are mounted between the first panel and the second panel, the first panel and the second panel are provided with oblong holes which are in one-to-one correspondence, and at least one of the sliding members is mounted between the oblong holes for adjusting a gap between the sliding subassembly and the guide rails.

2. The gap-adjustable sliding subassembly according to claim 1, wherein the sliding member is a pulley; and the sliding subassembly further comprises a bolt and a nut, the oblong holes which are in one-to-one correspondence form an oblong hole group, and a position of the pulley between the oblong holes relative to the oblong hole group is capable of being adjusted through the bolt and the nut.

3. The gap-adjustable sliding subassembly according to claim 2, wherein a bearing is arranged in a middle of the pulley between the oblong holes, and the bolt penetrates through the oblong hole in the first panel, a bearing hole in the pulley and the oblong hole in the second panel, and is threadedly connected with the nut.

4. The gap-adjustable sliding subassembly according to claim 3, wherein an inner-conical-surface countersink is arranged on one side of the oblong hole in the first panel opposite to the pulley, and an axis of the inner-conical-surface countersink coincides with or is close to an axis of the oblong hole in the first panel near the guide rail; and the bolt comprises an outer-conical-surface head, and the inner-conical-surface countersink is in contact with the outer-conical-surface head of the bolt.

5. The gap-adjustable sliding subassembly according to claim 4, wherein the nut is a polygon-section nut, a polygonal countersink is arranged on one side of the oblong hole in the second panel opposite to the pulley, the nut is mounted inside the polygonal countersink, and a wedge-shaped inclined surface in contact with the nut is arranged at a bottom of the polygonal countersink.

6. A sliding apparatus, comprising a guiding subassembly and a first sliding subassembly, wherein the first sliding subassembly is the sliding subassembly according to claim 1, the guiding subassembly comprises a first guide rail group, and the first guide rail group comprises oppositely arranged guide rails.

7. The sliding apparatus according to claim 6, further comprising a second sliding subassembly, wherein the second sliding subassembly is the sliding subassembly, and the guiding subassembly further comprises a second guide rail group, and the second guide rail group comprises oppositely arranged guide rails.

8. The sliding apparatus according to claim 6, wherein the guiding subassembly comprises a guide structural member and a support structural member, the guide rails are arranged on the guide structural member, and the guide structural member and the support structural member are connected end-to-end to form a rectangular frame of the guiding subassembly.

9. The sliding apparatus according to claim 8, wherein the support structural member comprises a first through hole and a wedge-shaped countersink, one end of the first through hole is connected with one end of the wedge-shaped countersink, and a combination of the first through hole and the wedge-shaped countersink penetrates through the support structural member; and an end of the guide structural member comprises a threaded hole, and the end of the guide structural member is fixedly connected with the support structural member by allowing a connecting member to penetrate through the wedge-shaped countersink, the first through hole and the threaded hole.

10. The sliding apparatus according to claim 9, wherein the connecting member comprises a wedge-shaped block and a fixing bolt, the wedge-shaped block is provided with a penetrative second through hole, the wedge-shaped block is mounted in the wedge-shaped countersink of the support structural member, and the fixing bolt penetrates through the second through hole and
the first through hole to connect with the guide structural member; and the support structural member further comprises a first positioning surface and a third positioning surface, the end of the guide structural member comprises a second positioning surface and a fourth positioning surface, the second positioning surface is in contact connection with the first positioning surface, and the third positioning surface is in contact connection with the fourth positioning surface.
